(19) United States
(12) Patent Application Publication
(10) Pub. No.: US 2024/0157754 A1
(43) Pub. Date: May 16, 2024

(54) HEAT EXCHANGER

(71) Applicant: MAHLE International GmbH, Stuttgart (DE)

(72) Inventors: Hannes STADLER, Ludwigsburg (DE); Uwe FOERSTER, Erdmannhausen (DE)

(73) Assignee: MAHLE International GmbH, Stuttgart (DE)

(21) Appl. No.: 18/509,762

(22) Filed: Nov. 15, 2023

(30) Foreign Application Priority Data
Nov. 15, 2022 (DE) 10 2022 212 151.1

(51) Int. Cl. B60H 1/00; F28F 27/00

(52) U.S. Cl. CPC B60H 1/00321; B60H 1/00885; F28F 27/00

(57) ABSTRACT

A heat exchanger with a heat transfer area, with a fluid collector and with a valve unit. The heat transfer area has a first fluid path for a first fluid flow and a second fluid path for the second fluid to flow through. The first fluid path is in thermal contact with the second fluid path for heat transfer between the first fluid and the second fluid. The fluid collector has a first fluid inlet and a first fluid outlet for the inflow of the first fluid into the fluid collector for the storage of the first fluid in the fluid collector and for the outflow of the first fluid from the fluid collector. The valve unit is provided and designed to control the fluid flow through the heat transfer area and/or the fluid collector. The heat transfer area, the fluid collector and the valve unit are designed as a single unit.

This nonprovisional application claims priority under 35 U.S.C. § 119(a) to German Patent Application No. 10 2022 212 151.1, which was filed in Germany on Nov. 15, 2022, and which is herein incorporated by reference.

### BACKGROUND OF THE INVENTION

### Field of the Invention

The invention relates to a heat exchanger, in particular an external heat exchanger of a refrigerant circuit, which can be effectively operated, for example, in an air conditioning mode as well as in a heat pump mode, in particular in a motor vehicle.

### Description of the Background Art

In motor vehicles, a refrigerant circuit is known, which is operated as an air conditioning circuit, in which a condenser is provided as an external heat exchanger, which is operated for desuperheating, condensing and subcooling the refrigerant, wherein the condenser has a first desuperheating and condensation area and a second subcooling area, wherein between the first desuperheating and condensation area and the second subcooling area there is a collector with drying and filter function, in which a defined storage of refrigerant takes place and also a phase separation of vaporous refrigerant and liquid refrigerant takes place in order to operate the subsequent subcooling in the subcooling area as far as possible only with liquid refrigerant, which has advantages for the subcooling of the refrigerant.

In motor vehicles, a refrigerant circuit is also known, which is operated as a heat pump circuit, which has an evaporator as an external heat exchanger, which has only one evaporation area. Such external heat exchangers, which are intended as evaporators, do not have a subcooling area and there is no provision for a collector that is interposed between two areas of the external heat exchanger.

If a refrigerant circuit is used both as an air conditioning circuit and as a heat pump circuit, an external heat exchanger, which is designed as a condenser, is less effective in the heat pump circuit because the collector and the subcooling section can have interfering influences. Also, an external heat exchanger, which is designed as an evaporator, is not very effective in the air conditioning circuit because the collector and the subcooling section are missing in the condenser function.

### SUMMARY OF THE INVENTION

It is therefore an object of the invention to provide a heat exchanger which can be used effectively as an external heat exchanger in both an air conditioning circuit and a heat pump circuit and which can also be operated and produced effectively.

An exemplary embodiment of the invention relates to a heat exchanger with a heat transfer area, with a fluid collector and with a valve unit, wherein the heat transfer area has a first fluid path for a first fluid flow and a second fluid path for a second fluid flow, wherein the first fluid path is in thermal contact with the second fluid path for heat transfer between the first fluid and the second fluid, wherein the fluid collector has a first fluid inlet and a first fluid outlet for the inflow of the first fluid into the fluid collector, for the storage of the first fluid in the fluid collector and for the outflow of the first fluid from the fluid collector, wherein the valve unit is provided and designed to control the fluid flow through the heat transfer area and/or the fluid collector, wherein the heat transfer area, the fluid collector and the valve unit are designed as a single unit. As a result, the heat exchanger can be used effectively in both a heat pump circuit and an air conditioning circuit due to the valve unit, wherein the heat exchanger can also be effectively manufactured and operated.

The fluid collector and/or the valve unit can be separably and/or inseparably connected to the heat transfer area. This allows for the heat exchanger to be manufactured effectively. In the case of a separable connection, for example of the valve unit, the latter can also be effectively maintained and replaced.

The fluid collector can be inseparably connected to the heat transfer area, in particular welded, soldered and/or glued, wherein the valve unit is connected to the heat transfer area and/or to the fluid collector in a separable and/or inseparable manner. This allows for the heat exchanger to be manufactured effectively. In the case of a separable connection, for example of the valve unit, the latter can also be effectively maintained and replaced.

The valve unit can be connected to the heat transfer area and/or to the fluid collector in a force-fit and/or form-fitting separable manner, or the valve unit can be connected to the heat transfer area and/or to the fluid collector in an inseparable manner, in particular welded, soldered and/or glued. As a result, the separable connection of the valve unit, for example, can also be effectively maintained and replaced.

The valve unit can be connected to the fluid collector as a pre-assembled unit, which is connected to the heat transfer area. This allows for the assembly to be designed effectively.

The valve unit can have fluid paths and at least one or more shut-off devices for releasing and/or shutting off at least one fluid path or fluid paths to control the fluid flow through the heat transfer area and/or the fluid collector. This achieves effective operation of the heat exchanger in the respective operating areas, so that the heat exchanger can be used effectively in both a heat pump circuit and an air conditioning circuit.

It is also useful if the valve unit has valves, check valves, expansion valves and/or filters. This means that the valve unit can not only switch between the operating ranges, but also take on additional functions as required.

The fluid collector can be part of the valve unit and/or part of the heat transfer area, in particular if the fluid collector is formed in one piece from the valve unit or from a part of the valve unit or from a part of the heat transfer area. This achieves effective manufacturability.

The valve unit can have a number of fluid inlets and fluid outlets by means of which the heat transfer area and the fluid collector are fluidly connected. This makes it possible to achieve a design without many internal pipe or hose connections, as the fluid connections are largely achieved by the valve unit itself.

The heat transfer area can be divided into a first heat transfer area and a second heat transfer area, each of which has a fluid inlet and a fluid outlet. As a result, the heat transfer area can be interconnected in a variety of ways, resulting in effective use of the heat exchanger.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of an example of a heat exchanger according to the invention,

FIG. 2 shows a schematic representation of an example of a heat exchanger according to the invention,

FIG. 3 shows a schematic representation of an example of a heat exchanger according to the invention,

FIG. 4 shows a schematic representation of an example of a heat exchanger according to the invention, and

FIG. 5 shows a schematic representation of an example of a heat exchanger according to the invention.

### DETAILED DESCRIPTION

The invention relates to a heat exchanger 1, which can be used in a refrigerant circuit, for example to be operated in a first operating state for an air conditioning circuit operation and/or to be operated in at least a second operating state for a heat pump circuit operation. The heat exchanger 1 is fluidically integrated into the refrigerant circuit and can, for example, be operated both as a condenser in air conditioning circuit mode and as an evaporator in heat pump circuit operation.

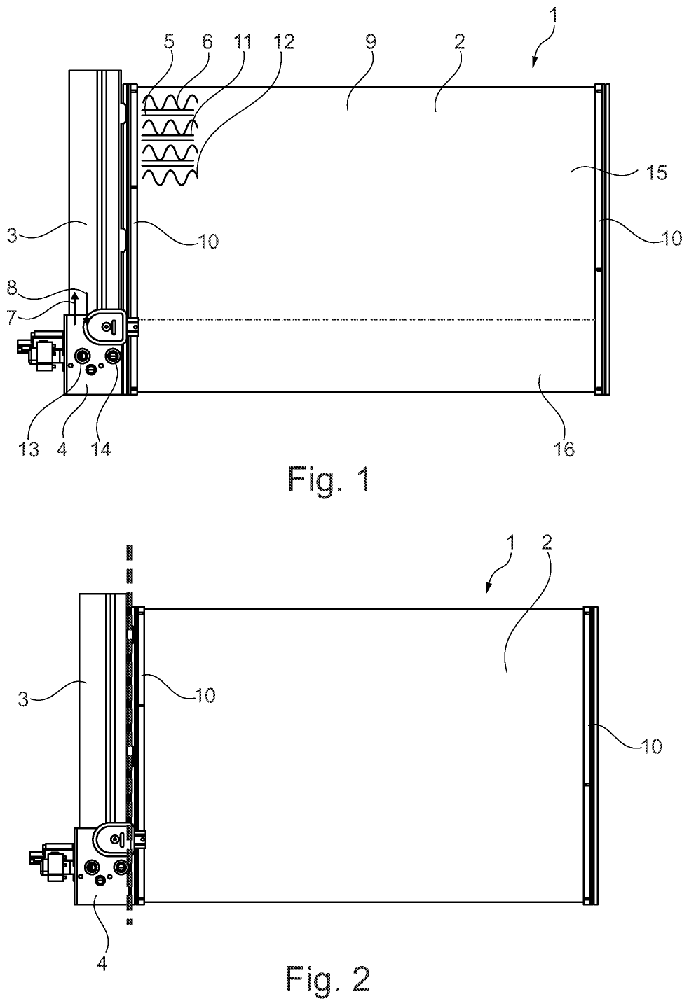

FIG. 1 shows a heat exchanger 1 of a first example with a heat transfer range 2. Furthermore, a fluid collector 3 and a valve unit 4 are provided, which together are designed as a single unit.

The heat transfer area 2 has a first fluid path 5 for a first fluid flow and a second fluid path 6 for a second fluid flow, wherein the first fluid path 5 is in thermal contact with the second fluid path 6 for heat transfer between the first fluid and the second fluid. The first fluid is in particular a refrigerant, the second fluid is in particular a coolant, such as air, water or a mixture of water, etc.

For example, the heat transfer area 2 is formed as a fin-tube block 9 with tubes 11 and fins 12 and laterally arranged manifolds 10, wherein the tubes 11 form the first fluid path 5 and the fins 12 between the tubes 11 form the second fluid path 6.

Alternatively, the heat transfer area 2 can also be designed in other ways, for example in stacking disc design, wherein first and second fluid paths 5, 6 are arranged between stacking discs and preferably arranged alternately.

The fluid collector 3 has a first fluid inlet 7 and a first fluid outlet 8 for the inflow of the first fluid into the fluid collector 3, for the storage of the first fluid in the fluid collector 3 and for the outflow of the first fluid from the fluid collector 3.

The valve unit 4 is provided and designed to control the fluid flow through the heat transfer area 2 and/or the fluid collector 3, wherein the heat transfer area 2, the fluid collector 3 and the valve unit 4 are designed as a single unit. This allows for the heat exchanger 1 to be mounted as a whole.

Preferably, it can be seen from FIG. 1 that the fluid collector 3 and/or the valve unit 4 is or are separably connected to the heat transfer area 2 in a separable and/or inseparable manner.

For example, the fluid collector 3 may be inseparably connected to the heat transfer area 2, in particular welded, soldered and/or glued, wherein the valve unit 4 is connected to the heat transfer area 2 and/or to the fluid collector 3 in a separable and/or inseparable manner.

FIG. 2 shows an example in which the fluid collector 3 is inseparably connected to the valve unit 4 and the unit of fluid collector 3 and valve unit 4 is separably connected to the heat transfer area 2. For example, the valve unit 4 and the fluid collector 3 form a pre-assembled unit connected to the heat transfer area 2.

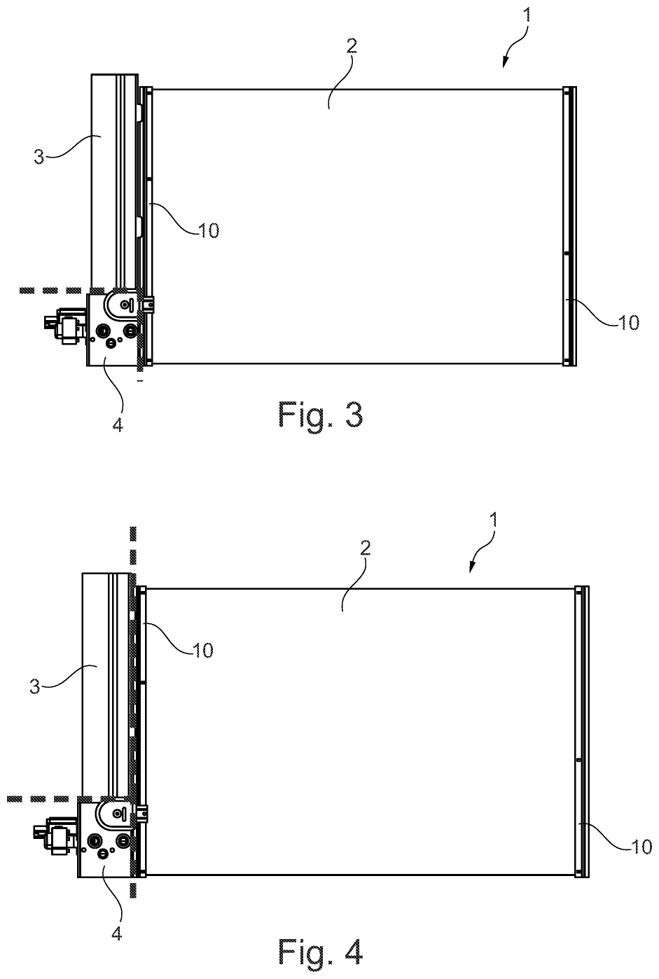

FIG. 3 shows an example in which the fluid collector 3 is inseparably connected to the heat transfer area 2 and the valve unit 4 is separably connected to the fluid collector 3 and separably connected to the heat transfer area 2.

FIG. 4 shows an example in which the fluid collector 3 is separably connected to the heat transfer area 2 and the valve unit 4 is separably connected to the fluid collector 3 and separably connected to the heat transfer area 2.

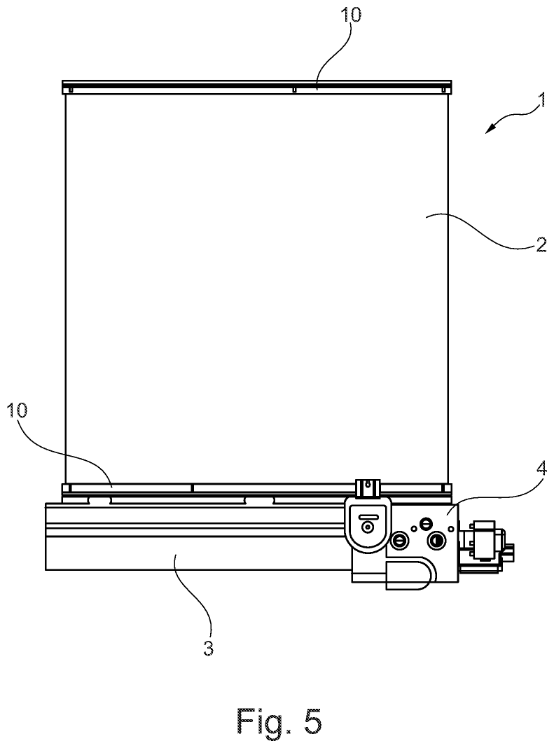

In the examples of FIGS. 1 to 4, the fluid collector 3 is arranged parallel to one of the manifolds 10 in a vertical orientation. In the example of FIG. 5, the fluid collector 3 is arranged parallel to one of the manifolds 10 in a horizontal orientation.

In principle, the valve unit 4 can be connected to the heat transfer area 2 and/or to the fluid collector 3 in a force-fit and/or form-fit separable manner. For example, the valve unit 4 can be stretched and bolted.

Alternatively, the valve unit 4 can be inseparably connected to the heat transfer area 2 and/or the fluid collector 3, in particular welded, soldered and/or glued.

According to FIG. 2, it is also advantageous if the fluid collector 3 is part of the valve unit 4 and/or is part of the heat transfer area 2 according to FIG. 3, in particular the fluid collector 3 is formed in one piece from the valve unit 4 or from a part of the valve unit 4 or from a part of the heat transfer area 2.

Preferably, the valve unit 4 has internal fluid paths and at least one or more shut-off devices for the release and/or shut-off of at least one or more fluid paths for controlling the fluid flow of the heat transfer area 2 and/or the fluid collector 3. As a result, external fluid connections, such as tubes or hoses, can be largely avoided.

It is also advantageous if the valve unit 4 has valves, check valves, expansion valves and/or filters. This allows for the valve unit to be a compact unit that, in addition to switching the fluid paths, also serves other purposes, such as filtering and/or relieving pressure of the first fluid, which is a refrigerant, for example.

Preferably, the valve unit has a number of fluid inlets 13 and fluid outlets 14, by means of which the heat transfer area 2 and the fluid collector 3 are fluidly connected.

It is also advantageous if the heat transfer area 2 is divided into a first heat transfer area 15 and a second heat transfer area 16, each of which has a fluid inlet and a fluid outlet. Thus, in the case of the condenser, the first heat transfer area 15 can serve as a desuperheating and condensation area, and the second heat transfer area 16 can serve as a subcooling area.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heat exchanger comprising:
a heat transfer area having a first fluid path for a first fluid flow and a second fluid path for a second fluid flow, the first fluid path being in thermal contact with the second fluid path for heat transfer between the first fluid and the second fluid;
a fluid collector having a first fluid inlet and a first fluid outlet for an inflow of the first fluid into the fluid collector for storage of the first fluid in the fluid collector and for an outflow of the first fluid from the fluid collector; and
a valve unit to control the fluid flow through the heat transfer area and/or the fluid collector,
wherein the heat transfer area, the fluid collector, and the valve unit are designed as a single unit.

2. The heat exchanger according to claim 1, wherein the fluid collector and/or the valve unit is or are separably and/or inseparably connected to the heat transfer area.

3. The heat exchanger according to claim 1, wherein the fluid collector is inseparably connected to the heat transfer area or is welded, soldered and/or glued, and wherein the valve unit is connected to the heat transfer area and/or to the fluid collector in a separable and/or inseparable manner.

4. The heat exchanger according to claim 2, wherein the valve unit is connected to the heat transfer area and/or to the fluid collector in a force-fit and/or form-fitting separable manner or wherein the valve unit is connected to the heat transfer area and/or to the fluid collector in an inseparable manner or is welded, soldered and/or glued.

5. The heat exchanger according to claim 1, wherein the valve unit is connected to the fluid collector as a pre-assembled unit connected to the heat transfer area.

6. The heat exchanger according to claim 1, wherein the valve unit has fluid paths and at least one or more shut-off devices for releasing and/or shutting off at least one or more fluid paths for controlling the fluid flow through the heat transfer area and/or the fluid collector.

7. The heat exchanger according to claim 1, wherein the valve unit has valves, check valves, expansion valves and/or filters.

8. The heat exchanger according to claim 1, wherein the fluid collector is part of the valve unit and/or part of the heat transfer area, and wherein the fluid collector is formed in one piece from the valve unit or from a part of the valve unit or from a part of the heat transfer area.

9. The heat exchanger according to claim 1, wherein the valve unit has a number of fluid inlets and fluid outlets via which the heat transfer area and the fluid collector are fluidly connected.

10. The heat exchanger according to claim 1, wherein the heat transfer area is divided into a first heat transfer area and a second heat transfer area, each having a fluid inlet and a fluid outlet.
